(19) United States
(12) Patent Application Publication
(10) Pub. No.: US 2016/0086359 A1
(43) Pub. Date: Mar. 24, 2016

(54) SYSTEM AND METHOD FOR DISPLAYING AN ELEVATION LINE FROM A RASTER IMAGE

(71) Applicant: Caterpillar Inc., Peoria, IL (US)

(72) Inventors: Brett Andrew Eisenmenger, Everton Hills (AU); Nataliya Roberts, Mt Gravatt East (AU)

(73) Assignee: Caterpillar Inc., Peoria, IL (US)

(21) Appl. No.: 14/491,429

(22) Filed: Sep. 19, 2014

(51) Int. Cl. G06T 11/20; G06T 17/05; G06F 17/30; G09G 5/14

(52) U.S. Cl. CPC G06T 11/203; G09G 5/14; G06T 17/05; G06F 17/30864

(57) ABSTRACT

A computer-implemented method includes receiving an input that includes a start point and an end point on a raster image. The method further includes generating a line of interest on the raster image that connects the start point and the end point. The method further includes determining available data points on the raster image that intersect with the generated line of interest. The method further includes generating a first query to retrieve an elevation line from a database, wherein the elevation line is generated on the basis of the determined available data points and is optimized on the basis of a resolution associated with a display device. The method further includes displaying the elevation line on the display device.

### TECHNICAL FIELD

The present disclosure generally relates to elevation data of a geographical zone, and more particularly, to a system and computer-implemented method for displaying an elevation line from a raster image.

### BACKGROUND

Typically, interfaces for presenting raster images corresponding to geographical zones such as, for e.g., a job site, may display the geographical zone in an aerial view or a top-down view. While aerial viewing or top-down viewing of the geographical zones may benefit fraternities involved in construction, mining, and other allied applications, such manner of displaying the geographical zones may present little or no data pertaining to a contour or elevation at different locations on the geographical zone.

U.S. Pa. No. 7,917,292 (hereinafter the '292 patent) relates to data points from flood maps i.e., geospatial flood risk zoning maps that may be used in generating a flood frequency versus flood elevation curve for reducing the uncertainty in the flood risk assessment. However, the '292 patent does not disclose any reference to displaying data pertaining to elevation at different locations on the geographical zone.

Hence, there is a need for a system and a method of displaying elevation at different locations on the geographical zone.

### SUMMARY OF THE DISCLOSURE

In one aspect of the present disclosure, a computer-implemented method includes receiving an input that includes a start point and an end point on a raster image. The method further includes generating a line of interest on the raster image that connects the start point and the end point. The method further includes determining available data points on the raster image that intersect with the generated line of interest. The method further includes generating a first query to retrieve an elevation line from a database, wherein the elevation line is generated on the basis of the determined available data points and is optimized on the basis of a resolution associated with a display device. The method further includes displaying the elevation line on the display device.

In another aspect of the present disclosure, a computer based system is provided for displaying an elevation line from a raster image. The system includes a database configured to store a raster image, a display device, a processor, and a memory in communication with the processor. The memory is configured to store a plurality of processing instructions for directing the processor to: receive an input including a start point and an end point on a raster image, generate a line of interest on the raster image connecting the start point and the end point, determine available data points on the raster image that intersect with the line of interest, the elevation line being generated on the basis of the determined available data points and optimized on the basis of a resolution associated with the display device; and display the elevation line on the display device on the basis of the obtained optimal resolution.

In yet another aspect of the present disclosure, a non-transitory computer-readable medium is provided. The non-transitory computer-readable medium has sequences of instruction stored thereon, the sequences of instruction including instruction which when executed by a computer-based system for displaying an elevation line from a raster image, causes the computer-based system to perform operations. In response to execution of instructions, the computer-based system receives an input including a start point and an end point on a raster image, generates a line of interest on the raster image connecting the start point and the end point, determines available data points on the raster image that intersect with the line of interest, generates an elevation line on the basis of the determined available data points, the elevation line being generated on the basis of the determined available data points and optimized on the basis of a resolution associated with the display device; and displays the elevation line on the display device.

Other features and aspects of this disclosure will be apparent from the following description and the accompanying drawings.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an exemplary environment in which an elevation generation module for displaying an elevation line from a raster image may be deployed, according to an embodiment of the present disclosure;

FIG. 2 is an exemplary implementation of the elevation generation module for generating the elevation line from the raster image, according to an embodiment of the present disclosure;

FIG. 3 is screenshot of an exemplary customizable interface for displaying the elevation line, in accordance with various embodiments of the disclosure;

FIG. 4 is a block diagram of an exemplary computer system, according to an embodiment of the present disclosure;

FIG. 5 is a flowchart illustrating a computer implemented method for displaying the elevation line from the raster image, according to an embodiment of the present disclosure; and

FIG. 6 is a low level flowchart showing steps in an exemplary implementation of the present disclosure, pursuant to the computer implemented method of FIG. 5.

### DETAILED DESCRIPTION

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure is described herein with reference to system architecture, block diagrams and flowchart illustrations of methods, and computer program products according to various aspects of the disclosure. It will be understood that each functional block of the block diagrams, screenshots and the flowchart illustrations, and combinations of functional blocks in the block diagrams, screenshots and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described as being combined into a single web page and/or window for the sake of simplicity may be expanded into multiple web pages and/or windows. In other cases, steps illustrated and described as single process steps may be separated into multiple web pages and/or windows but have been combined for simplicity.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The systems, methods and computer program products disclosed in conjunction with various embodiments of the present disclosure are embodied in systems, modules, and methods for displaying an elevation line from a raster image. Specific nomenclature used herein is merely exemplary and only used for descriptive purposes. Hence, such nomenclature must not be construed as being limiting of the scope of the present disclosure.

The present disclosure is now described in more detail herein in terms of the above disclosed exemplary embodiments of system, processes and computer program products. This is for convenience only and is not intended to limit the application of the present disclosure. In fact, after reading the following description, it will be apparent to one skilled in the relevant art(s) how to implement the following disclosure in alternative embodiments.

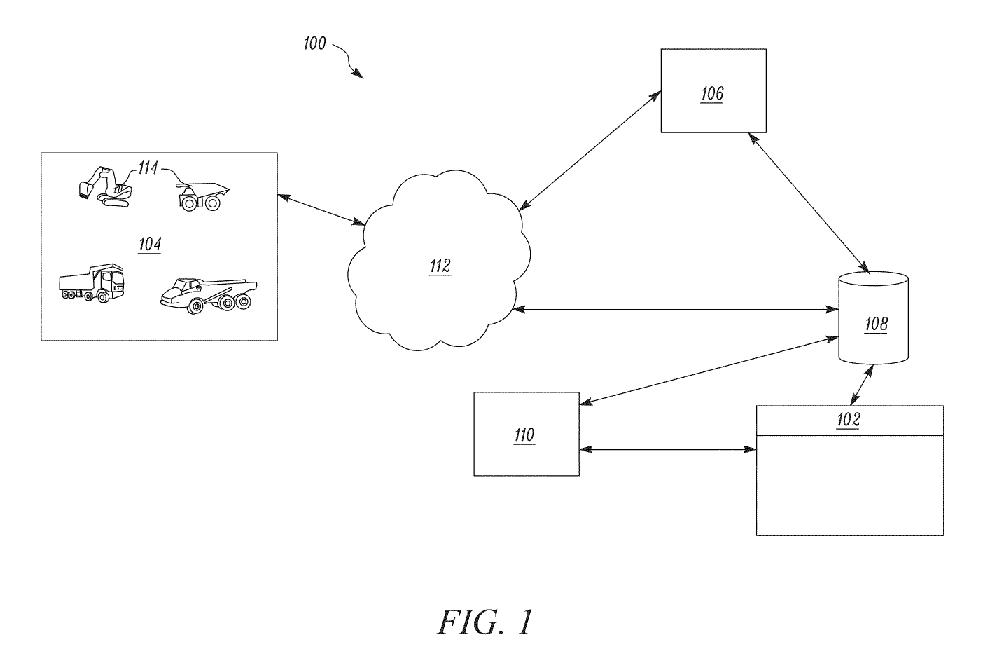

With reference to FIG. 1, an exemplary environment 100 is depicted, in which an elevation generation module 102 may be utilized, in accordance with an embodiment of the present disclosure. Environment 100 may include a job site 104, a raster image generation module 106, a database 108, a display device 110 and a communication network 112. Further, the job site 104 may have one or more machines 114 deployed thereon, for e.g., but not limited to, shovels, diggers, buckets, hydraulic excavators, motor graders and the like.

The machines 114 located on the job site 104, the raster image generation module 106, the database 108, and the display device 110 may communicate with each other over the communication network 112. Examples of communication network 112 may include, but are not limited to, a wide area network (WAN), a local area network (LAN), an Ethernet, Internet, an Intranet, a cellular network, a satellite network, or any other suitable network for transmitting data. Further, communication network 112 may be implemented as a wired network, a wireless network or a combination thereof.

Raster image generation module 106 and display device 110 may include any device (e.g., computing units), which communicates (in any manner discussed herein) with elevation generation module 102 via any network discussed herein. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. As will be appreciated by one of ordinary skill in the art, raster image generation module 106 and display device 110 may or may not be in direct contact with elevation generation module 102. For example, raster image generation module 106 and display device 110 may access the services of elevation generation module 102 via the communication network 112 (as shown) or through another server which may in turn be configured to establish a direct or indirect connection with the elevation generation module 102.

Further, raster image generation module 106 and display device 110 may include an operating system (e.g., Windows NT, 95/98/2000, OS2, UNIX, Linux, Solaris, MacOS, etc.) as well as various conventional support software and drivers typically associated with computers. Further, raster image generation module 106 and display device 110 may include any suitable personal computer, network computer, workstation, minicomputer, mainframe or the like. Furthermore, raster image generation module 106 and display device 110 may be in a home or business environment with access to communication network 112. In an exemplary embodiment of the present disclosure, access may be through a network or the Internet through a commercially available web-browser software package.

In an embodiment of the present disclosure, environment 100 may also include a data system, which may include a relational database (not shown) coupled to various other systems, illustrated in environment 100, directly or indirectly through communication network 112. The relational database may enable extraction and storage of data related to job site 104 that may be stored on database 108. In an embodiment of the present disclosure, database 108 may be part of such data system.

Database 108 may employ any type of database, such as relational, hierarchical, spatial, graphical, object-oriented, and/or other database configurations. Common database products that may be used to implement the databases may include DB2 by IBM (White Plains, N.Y.), various database products available from Oracle Corporation (Redwood Shores, Calif.), Microsoft Access or Microsoft SQL Server by Microsoft Corporation (Redmond, Wash.), PostgreSQL with PostGIS therein, or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables may be preferably the same or of the same type. However, data tables having similar, though not identical, data in the key fields may also be linked by using AGREP, for example. In accordance with one aspect of the disclosure, any suitable data storage technique may be utilized to store data without a standard format. Data sets may be stored using any suitable technique, including, for example, storing individual files using an ISO/DEC 7816-4 file structure; implementing a domain whereby a dedicated file may be selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats may be facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using one of fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first machine, a second data set which may be stored may be provided by an unrelated second machine, and yet a third data set which may be stored, may be provided by a third machine unrelated to the first and second machines. Each of these three exemplary data sets may contain different information that may be stored using different data storage formats and/or techniques. Further, each data set may contain subsets of data that also may be distinct from other subsets.

In an exemplary implementation as illustrated in FIG. 1, elevation generation module 102 may be deployed on the raster image generation module 106. In another exemplary embodiment, elevation generation module 102 may be connected to raster image generation module 106 through communication network 112.

Machines 114 may be associated with suitable system hardware and/or software and may use such system hardware and/or software to transmit data pertaining to elevation at various locations of the job site 104. This data may be communicated through communication network 112 to the raster image generation module 106. Additionally, such data may be stored at the database 108 upon receipt directly from the communication network 112, or indirectly via the communication network 112 and the raster image generation module 106.

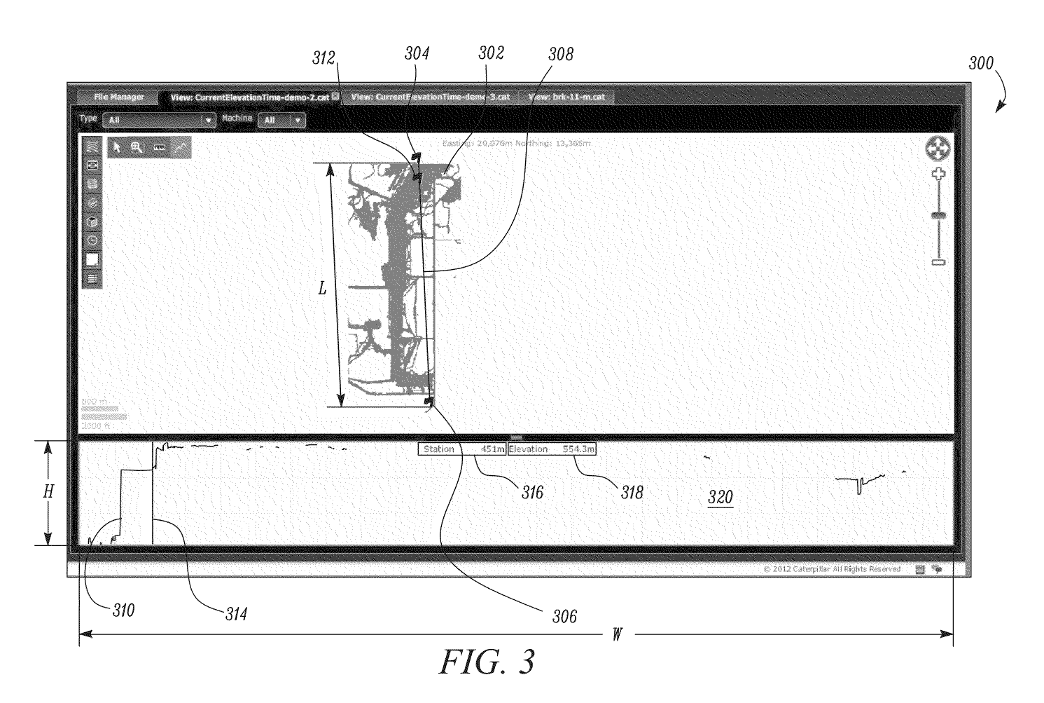

In various aspects of the present disclosure, it is contemplated that this data is consolidated at the raster image generation module 106 to represent a raster image 300 (See FIG. 3) pertaining to the job site 104. The consolidation of data may be executed at the raster image generation module 106. Therefore, the raster image 300 (as shown in FIG. 3) can be regarded as a collection of data points 310 corresponding to a geographical zone, in this case, the job site 104.

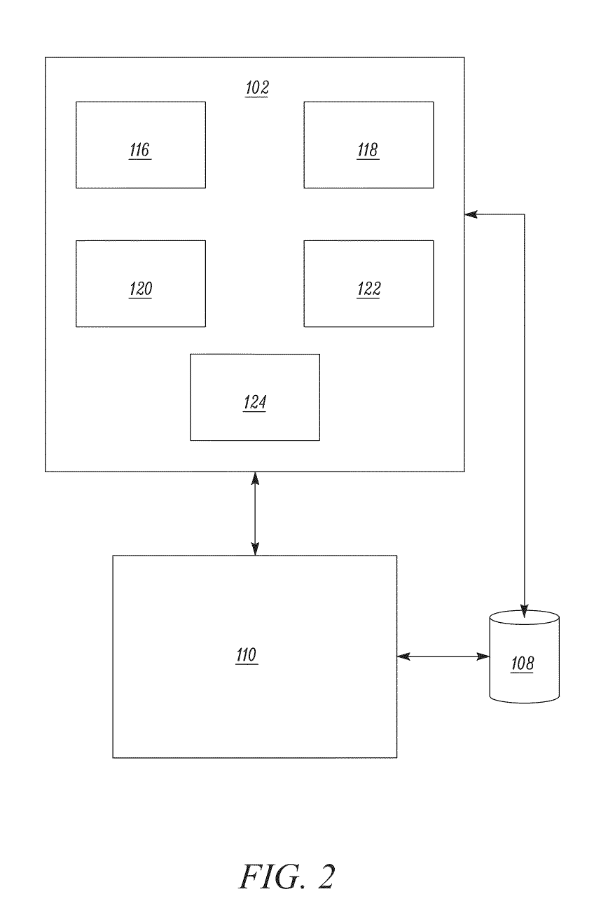

Referring to FIGS. 2 and 3, the elevation generation module 102, disclosed herein, may be operable for retrieving the raster image 300 from the raster image generation module 106, or the database 108 where the raster image 300 may be optionally stored. The elevation generation module 102 is configured to receive an input including a start point 302 and an end point 304 on the raster image 300. Specifically, in an embodiment as shown in FIG. 2, the elevation generation module 102 may include an input module 202 that allows a user to provide the start point 302 and the end point 304 on the raster image 300.

Referring to FIG. 3, the elevation generation module 102 is further configured to generate a line of interest 306 on the raster image 300 connecting the start point 302 and the end point 304. In an embodiment as shown in FIG. 2, the elevation generation module 102 may include a line generation module 204 in communication with the input module 202. Upon receiving the start point 302 and the end point 304 at the input module 202, this line generation module 204 may be configured to generate the line of interest 306 so that such generated line of interest 306 connects the start point 302 and the end point 304 provided by the user.

Referring to FIG. 3, the elevation generation module 102 is further configured to determine available data points 310 on the raster image 300 that intersect with the line of interest 306. As disclosed earlier herein, the raster image 300 is a collection of data points 310, wherein each data point 310 corresponds to an elevation at a location on the job site 104. In an embodiment as shown in FIG. 2, the elevation generation module 102 may include a first determination module 206 that is configured to determine available data points 310 on the raster image 300 that intersect with the line of interest 306.

Referring to FIG. 3, the elevation generation module 102 is further configured to generate an elevation line 308 on the basis of the determined available data points 310 that intersect with the line of interest 306. The elevation line 308 is generated by generating a first query and retrieving the elevation line 308 from the database 108 in response to the first query. The elevation generation module 102 may include an elevation line generating module 208 that is configured to generate the elevation line 308 on the basis of the determined available data points 310. Moreover, when generating the elevation line 308, the elevation line generating module 208 is further configured to optimize the elevation line 310 on the basis of a resolution associated with the display device 110. In an embodiment as shown in FIG. 2, the elevation generation module 102 may include an elevation line generating module 208 that is configured to generate the elevation line 308.

In an embodiment, the elevation generation module 102 may be configured to obtain the resolution of the display device 110, in this case, the display window 314 of the display device 110. In the exemplary raster image 300 of FIG. 3, the line of interest 306 is shown as intersecting the data points 310 (represented by the dark regions of the raster image 300). As such, the raster image 300 is also characterized by the presence of non-data points 312 i.e., points on the raster image 300 for which no data is available (represented by the white spaces interspersed between the dark regions of the raster image 300).

In an embodiment of the present disclosure, the optimal resolution for the elevation line 308 may be based at least in part on a length L associated with the line of interest 306, and a resolution of the display device 110. The length L of the line of interest 306 is defined as the distance between the start point 302 and the end point 304 provided by the user. Moreover, the resolution of the display device 110, disclosed herein, may be defined on the basis of a width W and height H of a display window 314 in the display device 110 (See FIG. 3).

In an embodiment as shown in FIG. 2, the elevation generation module 102 may further include a query module 210 that is configured to communicate with the display device 110, the determination module, and the line generation module 204. The query module 210 may generate a second query to determine all available data points 310 on the raster image 300 that intersect the line of interest 306. In response to the second query, the determination module may return a first pre-determined value, for e.g., 1, corresponding to data points 310 on the raster image 300 that intersect with the line of interest 306. The determination module may return a second pre-determined value, for e.g., 2, corresponding to non-data points 312 on the raster image 300 that intersect with the line of interest 306.

In an embodiment of the present disclosure, it is contemplated that as the query module 210 of the elevation generation module 102 is in communication with the display device 110, the query module 210 may also generate the first query for obtaining the resolution of the display device 110. Specifically, the query module 210 may generate the first query for obtaining the resolution of the display window 314 associated with the display device 110. As disclosed earlier herein, the resolution of the display window 314 is defined by its respective height H and width W. The height H and width W of the display window 314 may vary depending on a type and/or configuration of display device 110 used. This height H and width W, disclosed herein, is merely exemplary in nature and hence, non-limiting of this disclosure. The resolution of the display device 110 and/or the display window 314 therein may be optionally expressed in other forms, such as, but not limited to, pixels, for e.g., 540p, 720p, 1080p, and so on.

In response to the second query, the query module 210 may provide the resolution associated with the display window 314 to the elevation line generation module 208. Using the resolution of the display window 314, the elevation line generation module 208 can generate the elevation line 308 and optimize the elevation line 308 to the resolution of the display window 314 so that the generated elevation line 308 fits within the display window 314. Referring to FIGS. 2 and 3, the elevation generation module 102 then displays the elevation line 308 on the display device 110, in this case, the display window 314 of the display device 110.

The present disclosure has been described herein in terms of functional block components, screen shots, and various processing steps. It should be appreciated that such functional blocks may be realized by any number of hardware and/or software components configured to perform the specified functions. For example, elevation generation module 102 may employ various integrated circuit components, e.g., memory elements, processing elements, logic elements, look-up tables, and/or the like, which may carry out a variety of functions under the control of one or more microprocessors or other control devices. Similarly, the software elements of elevation generation module 102 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that elevation generation module 102 may employ any number of conventional techniques for data transmission, signaling, data processing, network control, and/or the like. Still further, elevation generation module 102 could be used to detect or prevent security issues with a user-side scripting language, such as JavaScript, VBScript or the like. In an embodiment of the present disclosure, the networking architecture between job site 104 and raster image generation module 106 may be client-server architecture. In an embodiment of the present disclosure, the client-server architecture may be built on a customizable .Net (dot-Net) platform. However, it may be apparent to a person ordinarily skilled in the art that various other software frameworks may be utilized to build the client-server architecture between job site 104 and raster image generation module 106 without departing from the spirit and scope of the disclosure.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce instructions which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The present disclosure (i.e., elevation generation module 102, raster image generation module 106, method 500, any part(s) or function(s) thereof) may be implemented using hardware, software or a combination thereof, and may be implemented in one or more computer systems or other processing systems. However, the manipulations performed by the present disclosure were often referred to in terms, such as comparing or checking, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices.

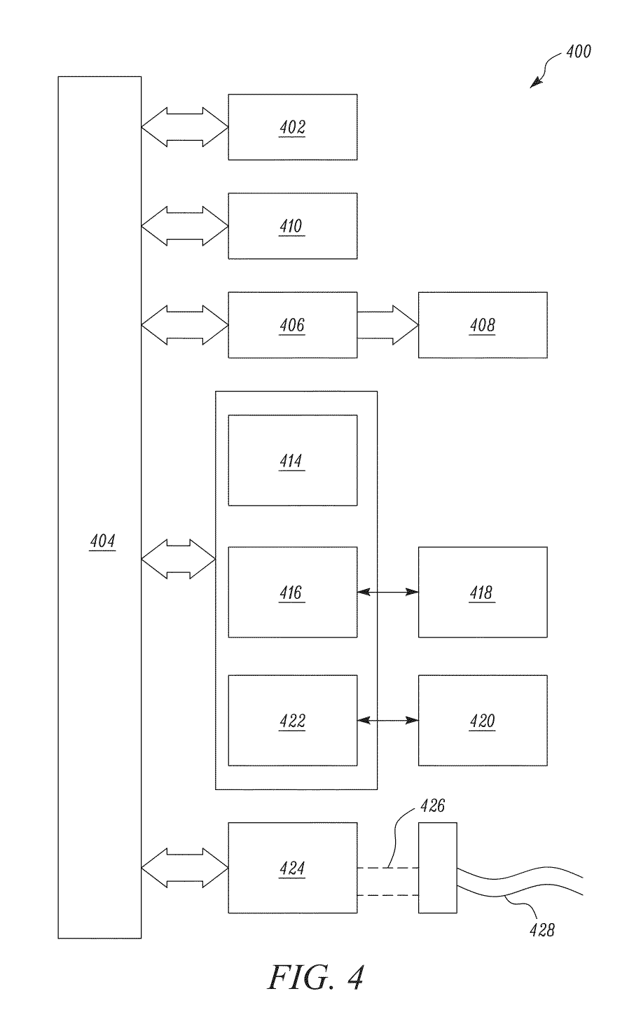

In fact, in accordance with an embodiment of the present disclosure, the present disclosure is directed towards one or more computer systems capable of carrying out the functionality described herein. An example of the computer based system includes a computer system 400, which is shown by way of a block diagram in FIG. 4.

Computer system 400 includes at least one processor, such as a processor 402. Processor 402 may be connected to a communication infrastructure 404, for example, a communications bus, a cross-over bar, a network, and the like. Various software embodiments are described in terms of this exemplary computer system 400. Upon perusal of the present description, it will become apparent to a person skilled in the relevant art(s) how to implement the present disclosure using other computer systems and/or architectures.

Computer system 400 includes a display interface 406 that forwards graphics, text, and other data from communication infrastructure 404 (or from a frame buffer which is not shown in FIG. 11) for display on a display unit 408.

Computer system 400 further includes a main memory 410, such as random access memory (RAM), and may also include a secondary memory 412. Secondary memory 412 may further include, for example, a hard disk drive 414 and/or a removable storage drive 416, representing a floppy disk drive, a magnetic tape drive, an optical disk drive, etc. Removable storage drive 416 reads from and/or writes to a removable storage unit 418 in a well known manner. Removable storage unit 418 may represent a floppy disk, magnetic tape or an optical disk, and may be read by and written to by removable storage drive 416. As will be appreciated, removable storage unit 418 includes a computer usable storage medium having stored therein, computer software and/or data.

In accordance with various embodiments of the present disclosure, secondary memory 412 may include other similar devices for allowing computer programs or other instructions to be loaded into computer system 400. Such devices may include, for example, a removable storage unit 420, and an interface 422. Examples of such may include a program cartridge and cartridge interface (such as that found in video game devices), a removable memory chip (such as an erasable programmable read only memory (EPROM), or programmable read only memory (PROM)) and associated socket, and other removable storage units 420 and interfaces 422, which allow software and data to be transferred from removable storage unit 420 to computer system 400.

Computer system 400 may further include a communication interface 424. Communication interface 424 allows software and data to be transferred between computer system 400 and external devices. Examples of communication interface 424 include, but may not be limited to a modem, a network interface (such as an Ethernet card), a communications port, a Personal Computer Memory Card International Association (PCMCIA) slot and card, and the like. Software and data transferred via communication interface 424 may be in the form of a plurality of signals, hereinafter referred to as signals 426, which may be electronic, electromagnetic, optical or other signals capable of being received by communication interface 424. Signals 426 may be provided to communication interface 424 via a communication path (e.g., channel) 428. Communication path 428 carries signals 426 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 416, a hard disk installed in hard disk drive 414, signals 426, and the like. These computer program products provide software to computer system 400. The present disclosure is directed to such computer program products.

Computer programs (also referred to as computer control logic) may be stored in main memory 410 and/or secondary memory 412. Computer programs may also be received via the communication interface 404. Such computer programs, when executed, enable computer system 400 to perform the functions consistent with the present disclosure, as discussed herein. In particular, the computer programs, when executed, enable processor 402 to perform the features of the present disclosure. Accordingly, such computer programs represent controllers of computer system 400.

In accordance with an embodiment of the present disclosure, where the disclosure is implemented using a software, the software may be stored in a computer program product and loaded into computer system 400 using removable storage drive 416, hard disk drive 414 or communication interface 424. The control logic (software), when executed by processor 402, causes processor 402 to perform the functions of the present disclosure as described herein.

In another embodiment, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

Various embodiments disclosed herein are to be taken in the illustrative and explanatory sense, and should in no way be construed as limiting of the present disclosure. All numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

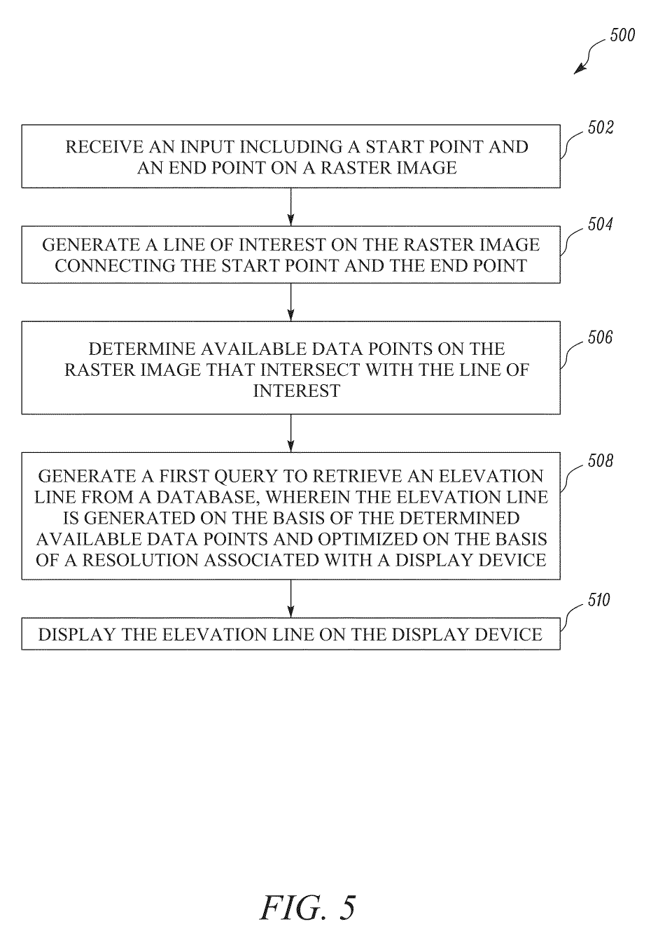

FIG. 5 is a flowchart illustrating a computer implemented method 500 for displaying the elevation line 308 from the raster image 300, according to an embodiment of the present disclosure.

At step 502, the method 500 includes receiving the input including the start point 302 and the end point 304 on the raster image 300. At step 504, the method 500 further includes generating the line of interest 306 on the raster image 300 that connects the start point 302 and the end point 304. At step 506, the method 500 further includes determining available data points 310 on the raster image 300 that intersect with the generated line of interest 306. At step 508, the method 500 further includes generating the first query to retrieve the elevation line 308 from the database 108. At step 508, the elevation line 308 that is being generated on the basis of the determined available data points 310 is further optimized on the basis of the resolution associated with the display device 110. In various aspects of the present disclosure, it should be noted that the steps of generating and optimizing the elevation line 308 may occur in a substantially simultaneous manner or in a tandem manner without limiting the scope of the present disclosure.

Moreover, in generating the elevation line 308, the resolution associated with the display device 110 may be obtained and the elevation line 308 may then be generated on the basis of the obtained resolution. As disclosed earlier herein, the query module 210 that is disposed in communication with the display device 110 may generate the second query, and receive the resolution of the display device 110 in response to the second query.

At step 510, the method 500 further includes displaying the elevation line 308 on the display device 110. The resolution, obtained at the elevation line generating module 208 may be used in generating and optimizing the generated elevation line 308 so that the elevation line 308 is configured to fit within the display window 314 of the display device 110.

In an aspect of the present disclosure, the method 500 may further include providing a first slide ruler 316, and a second slide ruler 318. As shown in FIG. 3, the first slide ruler 316 is associated with the line of interest 306 and is configured to indicate a position on the line of interest 306. The second slide ruler 318 is associated with the generated elevation line 308. A movement of the first slide ruler 316 along the line of interest 306 and a movement of the second slide ruler 318 on the generated elevation line 308 are synchronous with movement of a cursor (not shown) on the display device 110, in this case, the display window 314 of the display device 110. Specifically, a position of the second slide ruler 318 corresponds with a position of the cursor that the user may have maintained on the display window 314 of the display device 110 and the movement of the first slide ruler 316 and the movement of the second slide ruler 318 are synchronous with movement of the cursor.

Additionally, the method 500 may further include numerically indicating a position 320 (as shown in FIG. 3) of the first slide ruler 316 from the start point 302, and an altitude 322 corresponding to the data point 310 at which the first slide ruler 316 is positioned on the raster image 300.

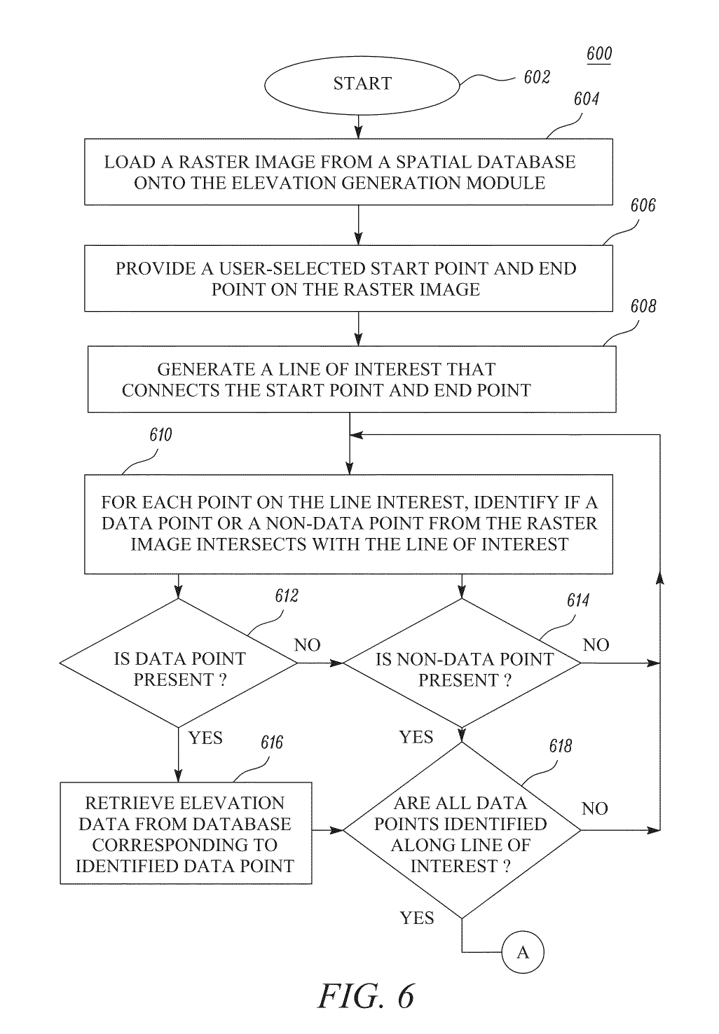

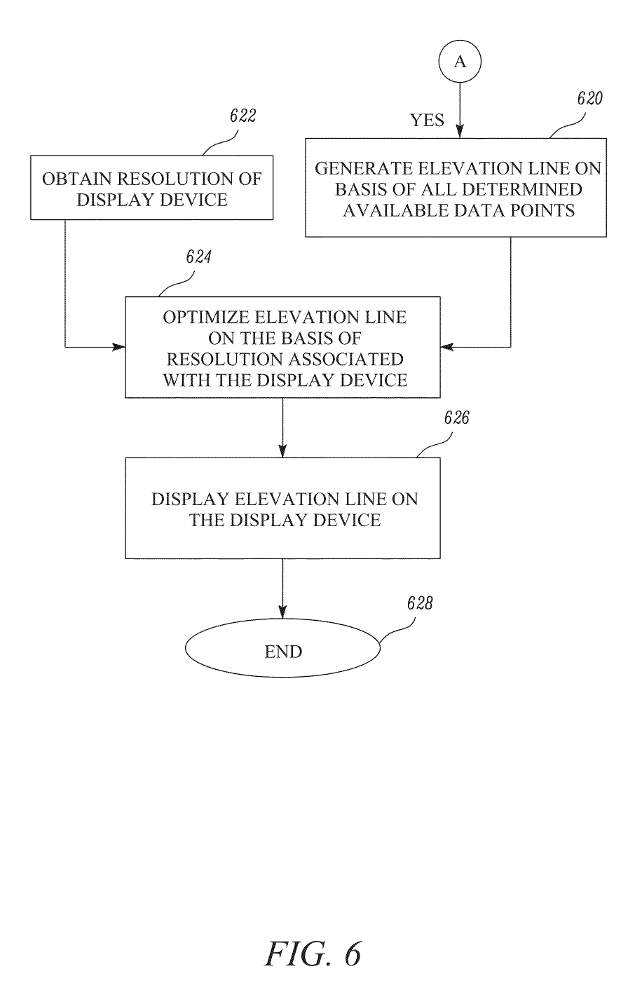

FIG. 6 illustrates a low level process flowchart 600 showing steps 602—in an exemplary implementation of the present disclosure, pursuant to the computer implemented method 500 of FIG. 5. While explaining the process 600 illustrated in FIG. 6, some aspects of the foregoing disclosure may be recapitulated or omitted for the purposes of better understanding of the present disclosure or for the sake of brevity in the present document. However, it should be noted that such explanation should not be construed as being limiting of this disclosure, rather the explanation pertaining to FIG. 6 should be taken merely in the illustrative and explanatory sense only.

Referring to FIG. 6, the process 600 is shown to initiate with a start step 602. At step 604, a raster image 300 corresponding to a job site 104 may be loaded from a spatial database 108 onto the elevation generation module 102. In order to execute step 604, the raster image 300 may be implemented by way of a raster file that contains the raster image 300 therein. Both the raster image 300 and the raster file containing the raster image 300 may be obtained from the raster image generation module 106 (See FIG. 1).

At step 606, a user-selected start point 302 and end point 304 may be provided on the raster image 300. At step 608, the line generation module 204 of the elevation generation module 102 may generate a line of interest 306 that connects with the start point 302 and the end point 304.

At step 610, the first determination module 206 may identify for each point on the line of interest 306, the presence of a data point 310 or a non-data point 312 intersecting the line of interest 306. As shown at steps 612 and 616, if a data point 310 is present on the raster image 300 that intersects the line of interest 306, then the database 108 may be queried to retrieve the elevation data corresponding to the identified data point 310 (See Step 616). At steps 614 and 618, if a non-data point 312 is identified as intersecting with the line of interest 306, then the process 600 returns to step 610 to identify the next available data point 310 that intersects with the line of interest 306. This process of returning to step 610 upon identification of a non-data point 312 occurs recursively until at least the next data point 310 is identified intersecting the line of interest 306 or until all the points on the line of interest 306 have been identified for the presence of data points 310 or non-data points 312 (See step 618).

As disclosed earlier herein, at step 612 and 616, upon detection of a data point 310 on the raster image 300 that intersects with the line of interest 306, the database 108 may be queried to retrieve the elevation data corresponding to the identified data point 310. At step 620, an elevation line 308 is generated on the basis of all determined available data points 310. At step 622, the process 600 further includes obtaining the resolution of the display device 110, more specifically, the resolution of the display window 314 present in the display device 110. At step 624, the resolution associated with the display device 110 is used to optimize the elevation line 308 such that the elevation line 308 fits within the display window 314 of the display device 110. At step 626, the generated and optimized elevation line 308 is now displayed on the display window 314 of the display device 110. The process 600 then terminates at step 628.

Embodiments of the present disclosure have applicability in generating an elevation line 308 from a raster image 300 and displaying the elevation line 308 on display devices on the basis of the length L associated with the line of interest 308 and the resolution of the display device 110 as defined by the height H and width W of the display window 314. With use of the method 500 disclosed herein, personnel associated with construction, mining, and other allied applications can quickly view data pertaining to elevation at various locations on the geographical zone. The use of the method 500, thus offers a simple yet simplified and integrated solution aimed at viewing elevation data corresponding to a geographical zone.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A computer-implemented method comprising:
receiving an input including a start point and an end point on a raster image;
generating a line of interest on the raster image connecting the start point and the end point;
determining available data points on the raster image that intersect with the line of interest;
generating a first query to retrieve an elevation line from a database, wherein the elevation line is generated on the basis of the determined available data points and is optimized on the basis of a resolution associated with a display device; and
displaying the elevation line on the display device.

2. The computer implemented method of claim 1, wherein generating the elevation line further includes:
obtaining the resolution associated with the display device; and
generating the elevation line on the basis of the obtained resolution.

3. The computer implemented method of claim 1, wherein the raster image is a collection of data points corresponding to a geographical zone.

4. The computer implemented method of claim 1, wherein the elevation line is optimized based at least in part on:
a length associated with the line of interest; and
a resolution of the display device.

5. The computer implemented method of claim 1, wherein the display device is a Graphical User Interface (GUI).

6. The computer implemented method of claim 1 further including generating a second query to determine all available data points on the raster image that intersect the line of interest.

7. The computer implemented method of claim 6 further including returning a first pre-determined value corresponding to data points on the raster image that intersect the line of interest.

8. The computer implemented method of claim 6 further including returning a second pre-determined value corresponding to non-data points on the raster image that intersect the line of interest.

9. The computer implemented method of claim 1 further comprising providing:
a first slide ruler associated with the line of interest; and
a second slide ruler associated with the generated elevation line, wherein a movement of the first slide ruler along the line of interest and a movement of the second slide ruler on the generated elevation line are synchronous with movement of a cursor on the display device.

10. The computer implemented method of claim 9 further comprising indicating numerically:
a position of the first slide ruler from the start point; and
an altitude corresponding to the data point at which the first slide ruler is positioned on the raster image.

11. A computer based system for displaying an elevation line from a raster image, the system comprising:
a database configured to store a raster image;
a display device;
a processor; and
a memory in communication with the processor, the memory for storing a plurality of processing instructions for directing the processor to:
receive an input including a start point and an end point on a raster image;
generate a line of interest on the raster image connecting the start point and the end point;
determine available data points on the raster image that intersect with the line of interest;
generate a first query to retrieve an elevation line from a database, wherein the elevation line is generated on the basis of the determined available data points, and wherein the elevation line is optimized on the basis of a resolution associated with the display device; and
display the elevation line on the display device.

12. The computer based system of claim 11, wherein the processor is configured to:
obtain the resolution associated with the display device; and
generate the elevation line on the basis of the obtained resolution.

13. The computer based system of claim 11, wherein the database is a spatial database.

14. The computer based system of claim 11, wherein the raster image is a collection of data points corresponding to a geographical zone.

15. The computer based system of claim 11, wherein the elevation line is optimized based at least in part on:
a length associated with the line of interest; and
a resolution of the display device.

16. The computer based system of claim 11, wherein the display device is a Graphical User Interface (GUI).

17. The computer based system of claim 11, wherein the processor generates a second query to determine all available data points on the raster that intersect the line of interest.

18. The computer based system of claim 17, wherein the processor returns a first pre-determined value corresponding to data points on the raster image that intersect the line of interest.

19. The computer based system of claim 17, wherein the processor returns a second pre-determined value corresponding to non-data points on the raster image that intersect the line of interest.

20. A non-transitory computer-readable medium having stored thereon sequences of instruction, the sequences of instruction including instruction which when executed by a computer-based system for displaying an elevation line from a raster image, causes the computer-based system to perform operations, comprising:
receiving, by the computer based system, an input including a start point and an end point on a raster image;
generating, by the computer based system, a line of interest on the raster image connecting the start point and the end point;
determining, by the computer based system, available data points on the raster image that intersect with the line of interest;
generating, by the computer based system, an elevation line on the basis of the determined available data points, wherein the elevation line is generated on the basis of the determined available data points, and wherein the elevation line is optimized on the basis of a resolution associated with the display device; and
displaying, by the computer based system, the elevation line on the display device.
